(19) United States
(12) Patent Application Publication
(10) Pub. No.: US 2015/0239998 A1
(43) Pub. Date: Aug. 27, 2015

(54) CATALYST COMPONENT FOR ETHYLENE POLYMERIZATION, PREPARATION THEREOF AND CATALYST COMPRISING THE SAME

(71) Applicants: Wei CHEN, Beijing (CN); Zifang Guo, Beijing (CN); Junling Zhou, Beijing (CN); Hongtao Wang, Beijing (CN); Hongxu Yang, Beijing (CN); Ruixia Li, Beijing (CN); Ruiping Wang, Beijing (CN)

(72) Inventors: Wei CHEN, Beijing (CN); Zifang Guo, Beijing (CN); Junling Zhou, Beijing (CN); Hongtao Wang, Beijing (CN); Hongxu Yang, Beijing (CN); Ruixia Li, Beijing (CN); Ruiping Wang, Beijing (CN)

(73) Assignees: China Petroleum & Chemical Corporation, Beijing (CN); Beijing Research Institute of Chemical Industry, Beijing (CN)

(21) Appl. No.: 14/611,626

(22) Filed: Feb. 2, 2015

Related U.S. Application Data
(63) Continuation of application No. 12/084,258, filed on Jul. 28, 2008.

(30) Foreign Application Priority Data
Oct. 31, 2005 (CN) 200510117427.0
Oct. 31, 2005 (CN) 200510117428.5

(51) Int. Cl. C08F 10/02

(52) U.S. Cl. CPC C08F 10/02

(57) ABSTRACT

The present invention relates to a catalyst component for ethylene polymerization, which comprises a reaction product of a magnesium complex, at least one titanium compound, at least one alcohol compound, at least one silicon compound, and optionally an organic aluminum compound. The silicon compound is an organic silicon compound having a general formula R¹ₓR²_{y}Si(OR³)₂, in which R¹ and R² are independently a hydrocarbyl or a halogen, R³ is a hydrocarbyl, 0≦x≦2, 0≦y≦2, 0≦z≦4, and x+y+z=4. The present invention further relates to a method for the preparation of the catalyst component and to a catalyst comprising the same. The catalysts according to the invention have virtues such as high catalytic activity, good hydrogen response, and narrow particle size distribution of polymer, and are especially suitable for a slurry process of ethylene polymerization and a combined process of ethylene polymerization, which requires a high activity of catalyst.

### CROSS REFERENCE OF RELATED APPLICATIONS

The present application is a continuation of application Ser. No. 12/084,258, having the 371(c) date as Jul. 28, 2008, which is a national phase entry of PCT/CN2006/002923, filed Oct. 31, 2006, which in turn claims the benefit of the Chinese Patent Application No. 200510117427.0, filed on Oct. 31, 2005, and the Chinese Patent Application No. 200510117428.5, filed on Oct.r 31, 2005. All of the prior applications are incorporated herein by reference in their entireties and for all purposes.

### FIELD OF THE INVENTION

The present invention relates to a catalyst component for ethylene polymerization, to preparation thereof, and to a catalyst comprising the same.

### BACKGROUND

It is known that catalyst systems containing titanium and magnesium are predominant catalysts in commercial production of polyethylene. The research on such catalysts focuses mainly on catalytic activity, particle morphology and particle size distribution of catalyst, hydrogen response of catalyst, copolymerization property of catalyst, etc. In slurry process of ethylene polymerization, it is required that the catalyst used has high catalytic activity, and the control of the particle size and the particle size distribution of the produced ethylene polymer is also very important. In ethylene polymerization, in particular, ethylene slurry polymerization, fine polymer particles are easily produced, and such fines will likely cause the generation of static charge and “dust” phenomenon, and sometimes result in agglomerates, which might block pipes of the production plant. The most effective approach for controlling the particle size and the particle size distribution of a polymer is to control the particle size and the particle size distribution of the catalyst.

In the prior art, in order to obtain a catalyst having uniform particle diameter and better particle morphology, one generally utilizes the following two methods to prepare the catalyst.

In the first method, a magnesium compound, for example magnesium dichloride, is dissolved in a solvent to form a homogeneous solution, then the solution is combined with a titanium compound and optionally an electron donor compound, to precipitate a solid comprising magnesium, titanium, and optionally the electron donor compound. The solid is further treated with a liquid titanium compound to give the particulate catalyst. See, for example, CN1099041A and CN1229092A. This conventional method has a drawback that the particle size and particle size distribution of the catalyst particles are controlled fully through the precipitation process, which is a process of recrystallizing magnesium-containing support and of which stable control is difficult.

For example, Patent Application CN1229092 discloses a catalyst component containing magnesium dichloride as support and titanium tetrachloride as active component, which catalyst component is prepared by dissolving MgCl₂ in a solvent system to form a homogeneous solution, then reacting the solution with TiCl₄ at low temperature in the presence of precipitator, phthalic anhydride, and raising slowly the temperature to precipitate solid catalyst component. When so prepared catalyst component is used in ethylene polymerization, the obtained polymers have good particle morphology, however, hydrogen response and catalytic activity of the catalyst are still not satisfied. Additionally, in the preparation of the catalyst component, it is necessary to use organic substance such as phthalic anhydride as precipitator to facilitate the precipitation of solids and a large amount of titanium tetrachloride is required. Therefore, on one hand, the presence of an anhydride may adversely affect the catalyst, and on the other hand, the use of a large amount of titanium tetrachloride will increase the production cost of the catalyst and aggravate the problem of environmental pollution. Furthermore, such a reaction system is likely viscous so that the preparation of catalyst is difficult.

In the second method, an active component of a catalyst is supported directly on an inert support, for example, silica and the like. Since silicas have particle diameter easily controlled and good particle morphology, particulate catalysts having uniform particles can be obtained. However, because the loaded amount of an active component on a support is limited, a so-prepared catalyst has a lower Ti content and thereby a lower polymerization activity. For example, Patent Application CN1268520 discloses a catalyst component containing magnesium dichloride and silica as support and titanium tetrachloride as active component, which catalyst component is prepared by reacting MgCl₂ with TiCl₄ in THF, combining the reaction mixture with alkyl aluminum treated SiO₂, and removing THF to form the catalyst component. Since the catalyst component has a lower Ti content, it exhibits lower catalytic activity when used in ethylene polymerization. Therefore, although this catalyst system is applicable to gas phase fluidized bed process of ethylene polymerization, it is not suitable for slurry process of ethylene polymerization due to its lower catalytic activity.

It is well known that, in slurry process of ethylene polymerization, in addition to high catalytic activity and desired particle size distribution, the catalysts used are required to have good hydrogen response in order to produce ethylene homopolymer and copolymer having good properties, in other words, the melt index of the final polymers should be easily regulated by changing hydrogen partial pressure during the polymerization to obtain different commercial grades of polyethylene resin. However, the aforesaid catalyst systems are still not satisfied in hydrogen response.

Thus, it is very desired to provide a catalyst useful in ethylene polymerization, especially slurry polymerization, which should have high catalytic activity, uniform particle diameter, narrow particle size distribution, and good hydrogen response.

### SUMMARY

An object of the invention is to provide a catalyst component for ethylene polymerization, which comprises a reaction product of a magnesium complex, at least one titanium compound, at least one alcohol compound, at least one silicon compound, and optionally an organic aluminum compound, wherein

the magnesium complex is a product obtained by dissolving a magnesium halide in a solvent system comprising an organic epoxy compound and an organo phosphorus compound;

the alcohol compound is linear or branched alkyl or cycloalkyl alcohol with 1 to 10 carbon atoms, or aryl or aralkyl alcohol with 6 to 20 carbon atoms, the alcohol compound being optionally substituted by one or more halogen atoms;

the titanium compound has a general formula Ti(OR)ₐX_{b}, in which R is a C₁-C₁₄ aliphatic or aromatic hydrocarbyl, X is a halogen, a is 0, 1 or 2, b is an integer of from 1 to 4, and a+b=3 or 4;

the silicon compound is organic silicon compound having a general formula R¹ₓR²_{y}Si(OR³)_{z}, in which R¹ and R² are independently a hydrocarbyl or a halogen, R³ is a hydrocarbyl, 0≦x≦2, 0≦y≦2, 0≦z≦4, and x+y+z=4;

the organic aluminum compound has a general formula AlR⁴ₙX¹₃₋ₙ, in which R⁴ is hydrogen or a hydrocarbyl having 1 to 20 carbon atoms, X¹ is a halogen, and n is a value satisfying 1<n≦3.

Another object of the invention is to provide a method for preparing the catalyst component according to the invention.

Still another object of the invention is to provide a catalyst for ethylene polymerization, which comprises a reaction product of:

(1) the above catalyst component; and

(2) an organoaluminum cocatalyst of formula AlR⁵ₙX²₃₋ₙ, in which R⁵ is hydrogen or a hydrocarbyl having 1 to 20 carbon atoms, X² is a halogen, and n is a value satisfying 1<n≦3.

Still another object of the invention is to provide a process for ethylene polymerization, which process comprises the steps of:

(i) contacting ethylene and optionally comonomer(s) with the catalyst according to the invention under polymerization conditions, to form a polymer; and

(ii) recovering the polymer formed in the step (i).

### DETAILED DESCRIPTION OF THE PREFERRED EMBODIMENTS

As used herein, the term “polymerization” intends to include homopolymerization and copolymerization. As used herein, the term “polymer” intends to include homopolymer, copolymer and terpolymer.

As used herein, the term “catalyst component” intends to means main catalyst component or procatalyst, which, together with a conventional cocatalyst, for example an alkyl alumimum, constitutes the catalyst for ethylene polymerization.

In one aspect, the present invention provides a catalyst component for ethylene polymerization, which comprises a reaction product of a magnesium complex, at least one titanium compound, at least one alcohol compound, at least one silicon compound, and optionally an organic aluminum compound. The catalyst component according to the invention has advantages, such as high catalytic activity, good hydrogen response, and narrow particle size distribution of polymer, and is very suitable for ethylene polymerization, particularly slurry process of ethylene polymerization, and combined polymerization process that requires high activity of catalyst.

The magnesium complex is a product obtained by dissolving a magnesium halide in a solvent system comprising an organic epoxy compound and an organo phosphorus compound. In general, such a product is a homogeneous and clear solution.

The magnesium halide is selected from the group consisting of magnesium dihalides, water or alcohol complexes of magnesium dihalide, and derivatives of magnesium dihalide in which one or two halogen atoms are replaced with hydrocarbyl groups or halogenated hydrocarbyl-oxy groups. The specific examples include magnesium dichloride, magnesium dibromide, phenoxy magnesium chloride, isopropoxy magnesium chloride, butoxy magnesium chloride, and the like, with magnesium dichloride being preferred. These magnesium halides may be used alone or in combination.

The organic epoxy compound constituting the solvent system is at least one selected from the group consisting of aliphatic epoxy compounds and diepoxy compounds, halogenated aliphatic epoxy compounds and diepoxy compounds, glycidyl ethers, and inner ethers, having from 2 to 8 carbon atoms. Examples include, but are not limited to, ethylene oxide, propylene oxide, butylene oxide, vinyl epoxy ethane, butadiene dioxide, epoxy chloropropane, glycidyl methyl ether, and diglycidyl ether.

The organo phosphorus compound constituting the solvent system is a hydrocarbyl ester or a halogenated hydrocarbyl ester of orthophosphoric acid or phosphorous acid. The examples include trimethyl orthophosphate, triethyl orthophosphate, tributyl orthophosphate, triphenyl orthophosphate, trimethyl phosphite, triethyl phosphite, tributyl phosphite and tribenzyl phosphite. These organo phosphorus compounds may be used alone or in combination.

In the formation of the magnesium complex, the amount of the organic epoxy compound used is in a range of from 0.2 to 10 moles, preferably from 0.3 to 4 moles; and the amount of the organo phosphorus compound used is in a range of from 0.1 to 10 moles, preferably from 0.2 to 4 moles, with respect to one mole of the magnesium halide.

In order to dissolve more sufficiently the magnesium halide, an inert diluent is optionally contained in the solvent system. The inert diluent comprises generally aromatic hydrocarbons or alkanes, as long as it can facilitate the dissolution of the magnesium halide. Examples of the aromatic hydrocarbons include benzene, toluene, xylene, chlorobenzene, dichlorobenzene, trichlorobenzene, chlorotoluene, and derivatives thereof Examples of the alkanes include linear alkanes, branched alkanes and cycloalkanes, having from 3 to 20 carbon atoms, for example, butane, pentane, hexane, cyclohexane, and heptane. These inert diluents may be used alone or in combination. The amount of the inert diluent, if used, is not especially limited, however, from the viewpoint of easiness of operation and economical efficiency, it is preferably used in an amount of from 0.2 to 10 liters with respect to one mole of the magnesium halide.

The alcohol compounds include linear or branched alkyl or cycloalkyl alcohols with 1 to 10 carbon atoms, or aryl or aralkyl alcohols with 6 to 20 carbon atoms, the alcohol compounds being optionally substituted by halogen atom(s). Examples of the alcohol compounds include: aliphatic alcohols, for example, methanol, ethanol, propanol, isopropanol, butanol, isobutanol, glycerol, hexanol, 2-methylpentanol, 2-ethylbutanol, n-heptanol, 2-ethylhexanol, n-octanol, decanol, and the like; cycloalkyl alcohols, for example, cyclohexanol, methyl cyclohexanol; aromatic alcohols, for example, benzyl alcohol, methyl benzyl alcohol, a-methyl benzyl alcohol, a, a-dimethyl benzyl alcohol, isopropyl benzyl alcohol, phenylethyl alcohol, phenol, and the like; halogen-containing alcohols, for example, trichloromethanol, 2,2,2-trichloroethanol, trichlorohexanol, and the like. Among these, ethanol, butanol, 2-ethylhexanol, and glycerol are preferred. These alcohol compounds may be used alone or in combination.

According to a preferred embodiment, a combination of the alcohol compounds, for example, a combination of ethanol and 2-ethylhexanol, is used. The alcohols constituting the combination of the alcohol compounds can be added simultaneously or separately. The ratio of the alcohols in the combination is not especially limited. However, in the case where a combination of ethanol and 2-ethylhexanol is used, the molar ratio of ethanol to 2-ethylhexanol is preferably in a range of from .

The organic aluminum compounds have a general formula AlR⁴ₙX¹₃₋ₙ, in which R⁴ is independently hydrogen or a hydrocarbyl having 1 to 20 carbon atoms, especially an alkyl, an aralkyl or an aryl; X¹ is a halogen, especially chlorine or bromine; and n is a value satisfying 1<n≦3. Examples include trimethyl aluminum, triethyl aluminum, triisobutyl aluminum, trioctyl aluminum, diethyl aluminum hydride, diisobutyl aluminum hydride, and alkyl aluminum halides such as diethyl aluminum chloride, di-isobutyl aluminum chloride, ethyl aluminum sesquichloride, and ethyl aluminum dichloride. Among these, alkyl aluminum halides are preferable, and diethyl aluminum chloride is most preferable. These organic aluminum compounds may be used alone or in combination. In the catalyst component according to the invention, the organic aluminum compound is an optional component. Adding an amount of the organic aluminum compound contributes to improve the activity and hydrogen response of the catalyst component, however, excessive organic aluminum compound might inhibit the activity of the catalyst component, and make the reaction system viscous, thereby going against the precipitation of the catalyst component. Therefore, the amount of the organic aluminum compound used is preferably in a range of from 0 to 5 moles, with respect to one mole of the magnesium halide.

The titanium compounds have a general formula Ti(OR)ₓX_{b}, in which R is a C₁-C₁₄ aliphatic or aromatic hydrocarbyl, X is a halogen, a is 0, 1 or 2, b is an integer of from 1 to 4, and a+b=3 or 4. Titanium tetrachloride, titanium tetrabromide, titanium tetraiodide, tetrabutoxy titanium, tetraethoxy titanium, triethoxy titanium chloride, titanium trichloride, diethoxy titanium dichloride, ethoxy titanium trichloride are preferred. These titanium compounds may be used alone or in combination.

The silicon compounds are organic silicon compounds having no active hydrogen and having a general formula R¹ₓR²_{y}Si(OR³)_{z}, in which R¹ and R² are independently a hydrocarbyl, preferably an alkyl having from 1 to 10 carbon atoms, or a halogen, R³ is a hydrocarbyl, preferably an alkyl having from 1 to 10 carbon atoms, x, y and z are integers, and 0≦x≦2, 0≦y≦2, 0≦z≦4, and x+y+z=4.

Examples of the silicon compounds represented by the above formula include tetramethoxysilicane, tetraethoxysilicane, tetrapropoxysilicane, tetrabutoxysilicane, tetra(2-ethylhexoxy)silicane, ethyltrimethoxysilicane, ethyltriethoxysilicane, methyltrimethoxysilicane, methyltriethoxysilicane, n-propyltriethoxysilicane, n-propyltrimethoxysilicane, decyltrimethoxysilicane, decyltriethoxysilicane, cyclopentyltrimethoxysilicane, cyclopentyltriethoxysilicane, 2-methylcyclopentyltrimethoxysilicane, 2,3-dimethylcyclopentyltrimethoxysilicane, cyclohexyltrimethoxysilicane, cyclohexyltriethoxysilicane, vinyltrimethoxysilicane, vinyltriethoxysilicane, t-butyltriethoxysilicane, n-butyltrimethoxysilicane, n-butyltriethoxysilicane, iso-butyltrimethoxysilicane, iso-butyltriethoxysilicane, cyclohexyltriethoxysilicane, cyclohexyltrimethoxysilicane, phenyltrimethoxysilicane, phenyltriethoxysilicane, chlorotrimethoxysilicane, chlorotriethoxysilicane, ethyltriisopropoxysilicane, vinyltributoxysilicane, trimethylphenoxysilicane, methyltriallyloxysilicane, vinyltriacetoxysilicane, dimethyldimethoxysilicane, dimethyldiethoxysilicane, diisopropyldimethoxysilicane, diisopropyldiethoxysilicane, t-butylmethyldimethoxysilicane, t-butylmethyldiethoxysilicane, t-amylmethyldiethoxysilicane, dicyclopentyldimethoxysilicane, dicyclopentyldiethoxysilicane, methylcyclopentyldiethoxysilicane, methylcyclopentyldimethoxysilicane, diphenyldimethoxysilicane, diphenyldiethoxysilicane, methylphenyldiethoxysilicane, methylphenyldimethoxysilicane, di(o-tolyl)dimethoxysilicane, di(o-tolyl)diethoxysilicane, di(m-tolyl)dimethoxysilicane, di(m-tolyl)diethoxysilicane, di(p-tolyl)dimethoxysilicane, di(p-tolyl)diethoxysilicane, trimethylmethoxysilicane, trimethylethoxysilicane, tricyclopentylmethoxysilicane, tricyclopentylethoxysilicane, dicyclopentylmethylmethoxysilicane, cyclopentyldimethylmethoxysilicane, etc. Among these, the preferred are tetraalkoxysilicanes, for example, tetraethoxysilicane and tetrabutoxysilicane, and the most preferred is tetraethoxysilicane. These silicon compounds may be used alone or in combination.

According to the invention, the finally obtained solid titanium-containing catalyst component should comprise the silicon compound in a sufficient amount so as to improve the combined properties of the catalyst. At the same time, the silicon compound functions as a precipitator, which facilitates the precipitation of the particles of the catalyst component. According to an embodiment of the invention, in the preparation of the solid catalyst component, it is possible to utilize other silicon compounds capable of forming the alkoxy group-containing organic silicon compounds mentioned above in situ, for example, silicon tetrachloride.

As indicated above, the catalyst component for ethylene polymerization according to the invention comprises a reaction product of the magnesium complex, the at least one titanium compound, the at least one alcohol compound, the at least one silicon compound, and optionally the organic aluminum compound, wherein the individual reactants are used in the following amounts: 0.1 to 10 moles, and preferably 1 to 4 moles for the alcohol compound; 0.05 to 1 moles for the organic silicon compound; 0 to 5 moles for the organic aluminum compound; and 1 to 15 moles, and preferably 2 to 10 moles for the titanium compound, with respect to one mole of the magnesium halide.

In an embodiment, the catalyst component according to the invention consists essentially of the aforesaid reaction product. Such a catalyst component may comprise: Ti: 4.5 to 7.5 wt %, Mg: 14 to 19 wt %, Cl: 58 to 68 wt %, Si: 0.2 to 1.2 wt %, alkoxy group: 4.0 to 8.5 wt %, P: 0.1 to 1.0 wt %, and Al: 0 to 0.6 wt %.

In another embodiment, the catalyst component of the invention may be obtained as a supported form on an inorganic oxide support.

Examples of the inorganic oxide support include, but are not limited to, SiO₂, Al₂O₃, and mixtures thereof, and are commercially available. The supports are generally of spherical shape, and have an average particle diameter of from 0.1 μm to 150 μm, preferably from 1 μm to 50 μm, and most preferably from 5 μm to 40 μm. It is preferable to use a silica having a large specific surface area, preferably from 80 m²/g to 300 m²/g, as the support. Such a silica support is in favor of enhancing the loaded amount of magnesium compound in the catalyst component, and thereby enhancing the loaded amount of active component of the catalyst, and to prevent the phenomenon that, when magnesium content is higher, irregular agglomerates of magnesium halide are present in the catalyst component so that the particle morphology of the catalyst component is inferior. Prior to use, the inert supports are preferably subjected to dewatering treatment by calcination or activating treatment by alkylation. If used, the inert supports are used in an amount of from 40 to 400 grams, and preferably from 80 to 150 grams, with respect to one mole of the magnesium halide in the magnesium complex.

When obtained as a supported form on an inorganic oxide support, the catalyst component according to the invention comprises: Ti: 1.5 to 4.5 wt %; Mg: 4 to 14 wt %; Cl: 20 to 40 wt %; alkoxy group: 1.5 to 4.5 wt %; P: 0.05 to 0.5 wt %; Al: 0 to 0.4 wt %; and the inert support: 20 to 80 wt %. It is understood that such catalyst components further comprise Si derived from the organic silicon compounds.

In another aspect, the present invention provides a method for preparing the catalyst component according to the invention, comprising the steps of:

(1) dissolving the magnesium halide in a solvent system comprising the organic epoxy compound and the organic phosphorus compound, the solvent system optionally but preferably further comprising the inert diluent, to form a homogeneous solution;

(2) adding the alcohol compound before, during or after the formation of the homogeneous solution, to finally form a magnesium halide-containing solution;

(3) contacting the solution obtained from step (2) with the titanium compound, with the silicon compound being added before, during or after the contacting, to form a mixture;

(4) heating the mixture slowly to a temperature of from 60° C. to 110° C. and maintaining at that temperature for a period of time, solids gradually precipitating during the heating; and

(5) recovering the solids formed in step (4), to obtain the catalyst component.

In the step (1), the temperature for dissolution may be in a range of from 40 to 110° C., and preferably from 50 to 90° C. The time for which the step (1) is conducted is not especially limited, however, it is generally preferable to maintain further a period of time of from 20 minutes to 5 hours, and preferably from 30 minutes to 2 hours after the solution has become clear.

Before, during or after dissolving the magnesium halide in a solvent system comprising the organic epoxy compound and the organic phosphorus compound to form the homogeneous solution, the alcohol compound is added to the reaction mixture. If the alcohol compound is added before or during the formation of the homogeneous solution, then the formed homogeneous solution is just the magnesium halide-containing solution from step (2). If the alcohol compound is added after the formation of the homogeneous solution, then it is preferable to stir the reaction mixture at a temperature of from 0 to 110° C., and preferably from room temperature to 90° C. for from 10 minutes to 5 hours, and preferably from 20 minutes to 2 hours, to form the magnesium halide-containing solution. For convenience, it is preferable to add the alcohol compound before or during the formation of the homogeneous solution.

Prior to the step (3), the organic aluminum compound is optionally added to the magnesium halide-containing solution from step (2) and the resultant mixture is allowed to react for a period of time, preferably from 10 minetes to 5 hours, and more preferably from 30 minetes to 2 hours. This reaction may be performed at a temperature of from 0 to 80° C., and preferably from room temperature to 50° C.

The step (3) is generally conducted at a low temperature, preferably at a temperature of from -40° C. to 20° C.

In the step (4), after the reaction mixture is heated slowly to the desired temperature, it may be maintained at that temperature for 30 minutes to 5 hours, and preferably 1 to 3 hours.

The recovering operation of step (5) includes, for example, filtering and washing with an inert diluent, and optionally drying. The recovering operation may be performed according to conventional processes known in the art.

Those skilled in the art will understand that the above preparation method is generally performed throughout under an inert atmosphere, for example, nitrogen or argon atmosphere.

In an embodiment, a combination of the alcohol compounds, for example, a combination of ethanol and 2-ethylhexanol, is used. The alcohols constituting the combination of the alcohol compounds can be added simultaneously or separately.

In another embodiment, the reaction in step (3) or (4) is carried out in the presence of the inorganic oxide support, to obtain the catalyst component of the invention supported on the inorganic oxide support.

In still another aspect, the invention provides a catalyst for ethylene polymerization, which comprises a reaction product of: (1) said catalyst component according to the invention; and (2) an organoaluminum cocatalyst of formula AlR⁵ₙX²₃₋ₙ, in which R⁵ is hydrogen or a hydrocarbyl having 1 to 20 carbon atoms, in particular, an alkyl, an aralkyl, or an aryl; X² is a halogen, in particular, chlorine or bromine; and n is a value satisfying 1<n≦3.

In an embodiment, the catalyst according to the invention consists of the reaction product of the component (1) and the component (2).

Examples of the organoaluminum cocatalyst include trimethyl aluminum, triethyl aluminum, triisobutyl aluminum, trioctyl aluminum, diethyl aluminum hydride, diisobutyl aluminum hydride, diethyl aluminum chloride, di-isobutyl aluminum chloride, ethyl aluminum sesquichloride, ethyl aluminum dichloride, and the like. Among these, trialkyl aluminums are preferable, and triethyl aluminum and triisobutyl aluminum are more preferable. These organoaluminum cocatalysts may be used alone or in combination.

In the catalyst according to the invention, the molar ratio of aluminum in the component (2) to the titanium in the component (1) is in a range of from 5 to 500, and preferably from 20 to 200.

In still another aspect, the invention provides a process for ethylene polymerization, which process comprises the steps of:

(i) contacting ethylene and optionally at least one comonomer with the catalyst according to the invention under polymerization conditions, to form a polymer; and

(ii) recovering the polymer formed in the step (i).

The comonomer may be selected from the group consisting of a-olefins and dienes, having from 3 to 20 carbon atoms. Examples of the a-olefins include propylene, 1-butene, 4-methyl-l-pentene, 1-hexene, 1-octene, styrene, methyl styrene, and the like. Examples of the dienes include dicyclopentadiene, vinyl norbornene, 5-ethylidene-2-norbornene, and the like.

The polymerization process can be carried out in liquid phase or gas phase. The catalyst according to the invention is particularly suitable for a slurry polymerization process, or a combined polymerization process including slurry phase polymerization, for example, a process consisting of slurry phase polymerization and gas phase polymerization.

Examples of medium useful in the liquid phase polymerization include saturated aliphatic and aromatic inert solvents, such as isobutane, hexane, heptane, cyclohexane, naphtha, raffinate, hydrogenated gasoline, kerosene, benzene, toluene, xylene, and the like.

In order to regulate the molecular weight of the final polymers, hydrogen gas is used as a molecular weight regulator in the polymerization process according to the invention.

The present invention utilizes organic silicon compounds having no active hydrogen as precipitators, so that during the preparation of the catalyst component, particles of the catalyst component can be easily precipitated. Thus, there is not the need to use a large amount of titanium tetrachloride to facilitate the precipitation of solids, and to treat the solids with titanium tetrachloride more than one times. As a result, the amount of titanium tetrachloride used can be reduced significantly. At the same time, the incorporation of the organic silicon compound contributes to the enhancement of the activity of the catalysts and the improvement of the particle morphology of the catalyst components as well as the improvement of the particle morphology of the polymers. When used in ethylene polymerization, the catalyst according to the invention exhibits good hydrogen response.

### EXAMPLES

The following examples are given for further illustrating the invention, but do not make limitation to the invention in any way.

### Example 1

(1) Preparation of a Catalyst Component

To a reactor, in which air had been sufficiently replaced with high pure N₂, were added successively 4.0 g of magnesium dichloride, 50 ml of toluene, 4.0 ml of epoxy chloropropane, 4.0 ml of tributyl phosphate, and 6.4 ml of ethanol. The mixture was heated to 70° C. with stirring. After the solid had been completely dissolved to form a homogeneous solution, the mixture was maintained at 70° C. for further one hour. The solution was cooled to 30° C., then 4.8 ml of 2.2M solution of diethyl aluminum chloride in were added dropwise thereto, and the reaction was maintained at 30° C. for one hour. The reaction mixture was cooled to -5° C., and 40 ml of TiCl₄ were added dropwise and slowly thereto, followed by the addition of 3 ml of tetraethoxy silicane. The reaction was allowed to continue for one hour. Then the temperature was raised slowly to 80° C., and the reaction was allowed to continue at that temperature for 2 hours. Then the stirring was stopped and the reaction mixture was allowed to stand still. The suspension was observed to separate very quickly into layers. After removing the supernatant, the residue was washed with toluene twice and with hexane four times, and then dried by a flow of high pure N₂. A solid catalyst component having good flowability and narrow particle size distribution was obtained. The composition of the catalyst component is shown in Table 1.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and a suspension of the solid catalyst component prepared above in hexane (containing 0.3 mg of Ti). The reactor was heated to 70° C., and hydrogen gas was added thereto until the pressure reached 0.28 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 2.

### Example 2

(1) A catalyst component was prepared according to the same procedure as described in Example 1, except for that the amount of ethanol was changed from 6.4 ml to 5.9 ml.

(2) Polymerization of ethylene was carried out according to the same procedure as described in Example 1. The composition of the catalyst component and the polymerization results are shown in Table 1 and Table 2, respectively.

### Example 3

(1) A catalyst component was prepared according to the same procedure as described in Example 2, except for that the amount of the solution of diethyl aluminum chloride was changed to 3.8 ml.

(2) Polymerization of ethylene was carried out according to the same procedure as described in Example 1. The composition of the catalyst component and the polymerization results are shown in Table 1 and Table 2, respectively.

### Example 4

(1) Preparation of a Catalyst Component

To a reactor, in which air had been sufficiently replaced with high pure N₂, were added successively 4.03 g of magnesium dichloride, 50 ml of toluene, 4.0 ml of epoxy chloropropane, 4.0 ml of tributyl phosphate, and 6.4 ml of ethanol. The mixture was heated to 70° C. with stirring. After the solid had been completely dissolved to form a homogeneous solution, the mixture was maintained at 70° C. for further one hour. The reaction mixture was cooled to −5° C., and 40 ml of TiCl₄ were added dropwise and slowly thereto, followed by the addition of 3 ml of tetraethoxy silicane. The reaction was allowed to continue for one hour. Then the temperature was raised slowly to 80° C., and the reaction was allowed to continue at that temperature for 2 hours. Then the stirring was stopped and the reaction mixture was allowed to stand still. The suspension was observed to separate very quickly into layers. After removing the supernatant, the residue was washed with toluene twice and with hexane four times, and then dried by a flow of high pure N₂. A solid catalyst component having good flowability and narrow particle size distribution was obtained. The composition of the catalyst component is shown in Table 1.

(2) Polymerization of ethylene was carried out according to the same procedure as described in Example 1. The polymerization results are shown in Table 2.

### Example 5

(1) A catalyst component was prepared according to the same procedure as described in Example 4, except for that the amount of tetraethoxysilicane was changed to 2 ml.

(2) Polymerization of ethylene was carried out according to the same procedure as described in Example 1. The composition of the catalyst component and the polymerization results are shown in Table 1 and Table 2, respectively.

### Example 6

(1) A catalyst component was prepared according to the same procedure as described in Example 4, except for that the amount of tetraethoxysilicane was changed to 1 ml.

(2) Polymerization of ethylene was carried out according to the same procedure as described in Example 1. The composition of the catalyst component and the polymerization results are shown in Table 1 and Table 2, respectively.

### Example 7

(1) A catalyst component was prepared according to the same procedure as described in Example 4, except for that the amount of tetraethoxysilicane was changed to 5 ml.

(2) Polymerization of ethylene was carried out according to the same procedure as described in Example 1. The composition of the catalyst component and the polymerization results are shown in Table 1 and Table 2, respectively.

### Example 8

(1) A catalyst component was prepared according to the same procedure as described in Example 4, except for that tetraethoxysilicane was replaced with silicon tetrachloride.

(2) Polymerization of ethylene was carried out according to the same procedure as described in Example 1. The composition of the catalyst component and the polymerization results are shown in Table 1 and Table 2, respectively.

### Example 9

(1) Preparation of a Catalyst Component

To a reactor, in which air had been sufficiently replaced with high pure N₂, were added successively 4.03 g of magnesium dichloride, 50 ml of toluene, 2.0 ml of epoxy chloropropane, 6.0 ml of tributyl phosphate, and 3.4 ml of ethanol. The mixture was heated to 70° C. with stirring. After the solid had been completely dissolved to form a homogeneous solution, the mixture was maintained at 70° C. for further one hour. The reaction mixture was cooled to -5° C., and 60 ml of TiC1₄ were added dropwise and slowly thereto, followed by the addition of 3 ml of tetraethoxy silicane. The reaction was allowed to continue for one hour. Then the temperature was raised slowly to 80° C., and the reaction was allowed to continue at that temperature for 2 hours. Then the stirring was stopped and the reaction mixture was allowed to stand still. The suspension was observed to separate very quickly into layers. After removing the supernatant, the residue was washed with toluene twice and with hexane four times, and then dried by a flow of high pure N₂. A solid catalyst component having good flowability and narrow particle size distribution was obtained. The composition of the catalyst component is shown in Table 1.

(2) Polymerization of ethylene was carried out according to the same procedure as described in Example 1. The polymerization results are shown in Table 2.

### Example 10

(1) Preparation of a Catalyst Component

To a reactor, in which air had been sufficiently replaced with high pure N₂, were added successively 8.0 Kg of magnesium dichloride, 100 liters of toluene, 4.0 liters of epoxy chloropropane, 12 liters of tributyl phosphate, and 6.9 liters of ethanol. The mixture was heated to 70° C. with stirring. After the solid had been completely dissolved to form a homogeneous solution, the mixture was maintained at 70° C. for further one hour. The reaction mixture was cooled to -5° C., and 120 liters of TiC1₄ were added dropwise and slowly thereto, followed by the addition of 6.0 liters of tetraethoxy silicane. The reaction was allowed to continue for one hour. Then the temperature was raised slowly to 80° C., and the reaction was allowed to continue at that temperature for 2 hours. Then the stirring was stopped and the reaction mixture was allowed to stand still. The suspension was observed to separate very quickly into layers. After removing the supernatant, the residue was washed with hexane four times, and then dried under vacuum. A solid catalyst component having good flowability and narrow particle size distribution was obtained. The composition of the catalyst component is shown in Table 1.

(2) Polymerization of ethylene was carried out according to the same procedure as described in Example 1. The polymerization results are shown in Table 2.

### Comparative Example 1

(1) A catalyst component was prepared according to the same procedure as described in Example 4, except for that tetraethoxysilicane was replaced with phthalic anhydride.

(2) Polymerization of ethylene was carried out according to the same procedure as described in Example 4. The composition of the catalyst component and the polymerization results are shown in Table 1 and Table 2, respectively.

### Comparative Example 2

(1) The procedure as described in Example 4 (1) was repeated, except for that tetraethoxysilicane was not used. It was observed that the precipitation of the catalyst component was difficult, and the precipitated particles were extremely fine so that settlement was very difficult. When filtration under suction was performed through a 4G sintered glass filter, the solid catalyst component all passed through the filter and no catalyst component was obtained.

It can be seen from the polymerization results shown in Table 2 that, under the same polymerization conditions, the catalysts according to the invention exhibit higher activities. Furthermore, due to the incorporation of the organic silicon compound into the catalyst components according to the invention, the precipitation of the catalyst component was easier, the particle size distribution of the resultant polymers was narrower than that in Comparative Example 1 (using phthalic anhydride as precipitator), and both the excessively large particles and the excessively small particles are less.

TABLE 1
Compositions of the catalyst components

| | Ti | Mg | Cl | Si | OEt | P |
|---|---|---|---|---|---|---|
| No. | (wt %) | (wt %) | (wt %) | (wt %) | (wt %) | (wt %) |
| Example 1 | 6.1 | 16.0 | 60.0 | 0.2 | 6.7 | 0.49 |
| Example 2 | 5.9 | 16.0 | 59.0 | 0.2 | 6.4 | 0.40 |
| Example 3 | 6.2 | 15.0 | 59.0 | 0.3 | 6.5 | 0.51 |
| Example 4 | 5.6 | 16.0 | 61.0 | 0.3 | 6.3 | 0.52 |
| Example 5 | 5.8 | 17.0 | 59.0 | 0.2 | 6.1 | 0.48 |
| Example 6 | 5.7 | 17.0 | 60.0 | 0.1 | 5.9 | 0.49 |
| Example 7 | 6.0 | 16.0 | 60.0 | 0.4 | 6.4 | 0.51 |
| Example 8 | 5.9 | 17.0 | 62.0 | 0.2 | 6.3 | 0.55 |
| Example 9 | 5.6 | 16.0 | 60.0 | 0.4 | 6.3 | 0.49 |
| Example 10 | 5.7 | 16.0 | 60.0 | 0.3 | 6.3 | 0.49 |
| Comparative | 5.5 | 16.0 | 60.0 | — | — | — |
| Example 1 | | | | | | |

TABLE 2
Polymerization Results

| | Activity | BD | MI_{2.16} | Particle size distribution of polymer (mesh) | | | |
|---|---|---|---|---|---|---|---|
| No. | 10⁴gPE/gCat. | g/cm⁻³ | g/10min | <20 | 20-100 | 100-200 | >200 |
| Example 1 | 4.8 | 0.31 | 0.6 | 0.8 | 93.4 | 5.1 | 0.7 |
| Example 2 | 4.5 | 0.30 | 0.5 | 1.3 | 94.3 | 3.8 | 0.6 |
| Example 3 | 4.3 | 0.31 | 0.6 | 0.5 | 94.2 | 4.3 | 1.0 |
| Example 4 | 4.7 | 0.30 | 0.8 | 1.3 | 95.6 | 2.8 | 0.3 |
| Example 5 | 4.3 | 0.29 | 0.7 | 2.6 | 92.2 | 4.0 | 1.2 |
| Example 6 | 4.1 | 0.30 | 0.6 | 4.1 | 89.5 | 5.6 | 0.8 |
| Example 7 | 4.3 | 0.30 | 0.6 | 0.7 | 96.5 | 2.1 | 0.7 |
| Example 8 | 4.2 | 0.31 | 0.6 | 2.2 | 91.7 | 5.2 | 0.9 |
| Example 9 | 5.1 | 0.36 | 0.7 | 0.5 | 93.9 | 5.3 | 0.3 |
| Example 10 | 4.9 | 0.35 | 0.5 | 1.7 | 88.0 | 9.9 | 0.4 |
| Comparative | 4.0 | 0.30 | 0.4 | 12.1 | 77.9 | 7.8 | 2.2 |
| Example 1 | | | | | | | |

### Example 11

(1) Preparation of a Catalyst Component

To a reactor, in which air had been sufficiently replaced with high pure N₂, were added successively 4.0 g of magnesium dichloride, 80 ml of toluene, 4.0 ml of epoxy chloropropane, 4.0 ml of tributyl phosphate, and 6.4 ml of ethanol. The mixture was heated to 70° C. with stirring. After the solid had been completely dissolved to form a homogeneous solution, the mixture was maintained at 70° C. for further one hour. The solution was cooled to 30° C., then 4.8 ml of 2.2M solution of diethyl aluminum chloride in were added dropwise thereto, and the reaction was maintained at 30° C. for one hour. The reaction mixture was cooled to -25° C., and 40 ml of TiC1₄ were added dropwise and slowly thereto, the reaction was allowed to continue under stirring for 0.5 hours. Then treated inert support was added to the reaction mixture, and the reaction was allowed to continue under stirring for 0.5 hours. Next, 3 ml of tetraethoxy silicane were added to the reaction mixture, and the reaction was allowed to continue for 1 hour. Then the temperature was raised slowly to 85° C., and the reaction was allowed to continue at that temperature for 2 hours. Then the stirring was stopped and the reaction mixture was allowed to stand still. The suspension was observed to separate very quickly into layers. After removing the supernatant, the residue was washed with toluene twice and with hexane four times, and then dried by a flow of high pure N₂. A solid catalyst component having good flowability and narrow particle size distribution was obtained.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and 10 mg of the solid catalyst component prepared above. The reactor was heated to 70° C., and hydrogen gas was added thereto until the pressure reached 0.28 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 3.

### Example 12

(1) A catalyst component was prepared according to the same procedure as described in Example 11, except for that the amount of ethanol was changed from 6.4 ml to 5.9 ml.

(2) Polymerization of ethylene was carried out according to the same procedure as described in Example 11. The polymerization results are shown in Table 3.

### Example 13

(1) A catalyst component was prepared according to the same procedure as described in Example 11, except for that the amount of ethanol was changed from 6.4 ml to 3.2 ml.

(2) Polymerization of ethylene was carried out according to the same procedure as described in Example 11. The polymerization results are shown in Table 3.

### Example 14

1) A catalyst component was prepared according to the same procedure as described in Example 12, except for that no diethyl aluminum chloride was used.

(2) Polymerization of ethylene was carried out according to the same procedure as described in Example 11. The polymerization results are shown in Table 3.

### Example 15

(1) A catalyst component was prepared according to the same procedure as described in Example 13, except for that no diethyl aluminum chloride was used.

(2) Polymerization of ethylene was carried out according to the same procedure as described in Example 11. The polymerization results are shown in Table 3.

### Example 16

(1) Preparation of a Catalyst Component

To a reactor, in which air had been sufficiently replaced with high pure N₂, were added successively 4.03 g of magnesium dichloride, 50 ml of toluene, 4.0 ml of epoxy chloropropane, 4.0 ml of tributyl phosphate, and 6.4 ml of ethanol. The mixture was heated to 70° C. with stirring. After the solid had been completely dissolved to form a homogeneous solution, the mixture was maintained at 70° C. for further one hour. The reaction mixture was cooled to -25° C., and thereto was added 5 g of inert support, and then the reaction was allowed to continue under stirring for 0.5 hours. Next, 40 ml of TiC1₄ were added dropwise and slowly thereto, followed by the addition of 3 ml of tetraethoxy silicane. The reaction was allowed to continue for one hour. Then the temperature was raised slowly to 85° C., and the reaction was allowed to continue at that temperature for 2 hours. Then the stirring was stopped and the reaction mixture was allowed to stand still. The suspension was observed to separate very quickly into layers. After removing the supernatant, the residue was washed with toluene twice and with hexane four times, and then dried by a flow of high pure N₂. A solid catalyst component having good flowability and narrow particle size distribution was obtained.

(2) Polymerization of ethylene was carried out according to the same procedure as described in Example 11. The polymerization results are shown in Table 3.

### Example 17

(1) A catalyst component was prepared according to the same procedure as described in Example 14, except for that the amount of tetraethoxysilicane was changed to 4 ml.

(2) Polymerization of ethylene was carried out according to the same procedure as described in Example 11. The polymerization results are shown in Table 3.

### Example 18

(1) A catalyst component was prepared according to the same procedure as described in Example 14, except for that the amount of tetraethoxysilicane was changed to 5 ml.

(2) Polymerization of ethylene was carried out according to the same procedure as described in Example 11. The polymerization results are shown in Table 3.

### Example 19

(1) A catalyst component was prepared according to the same procedure as described in Example 14, except for that tetraethoxysilicane was replaced with silicon tetrachloride.

(2) Polymerization of ethylene was carried out according to the same procedure as described in Example 11. The polymerization results are shown in Table 3.

### Example 20

(1) A catalyst component was prepared according to the same procedure as described in Example 14, except for that the 5.9 ml of ethanol were replaced with 16.4 ml of isooctanol.

(2) Polymerization of ethylene was carried out according to the same procedure as described in Example 11. The polymerization results are shown in Table 3.

TABLE 3

| | Ti | Mg | Cl | Activity | BD | MI_{2.16} | Particle size distribution of polymer (mesh) | | | |
|---|---|---|---|---|---|---|---|---|---|---|
| No. | (wt %) | (wt %) | (wt %) | 10⁴gPE/gCat. | g/cM⁻³ | g/10min | <20 | 20-100 | 100-200 | >200 |
| Example 11 | 3.6 | 8.1 | 30.1 | 21.5 | 0.35 | 0.9 | 2.0 | 95.0 | 3.0 | / |
| Example 12 | 3.5 | 8.0 | 30.0 | 23.1 | 0.36 | 1.0 | 1.2 | 96.3 | 2.5 | / |
| Example 13 | 3.1 | 8.2 | 29.8 | 25.4 | 0.35 | 0.8 | 0.5 | 96.2 | 3.3 | / |
| Example 14 | 3.3 | 8.1 | 30.0 | 24.1 | 0.35 | 0.8 | 0.8 | 97.1 | 2.1 | / |
| Example 15 | 3.2 | 7.9 | 30.0 | 26.4 | 0.36 | 0.7 | 1.0 | 97.2 | 2.8 | / |
| Example 16 | 3.3 | 8.0 | 30.0 | 25.5 | 0.35 | 0.9 | 0.5 | 96.7 | 2.8 | / |
| Example 17 | 3.4 | 8.2 | 30.1 | 24.8 | 0.36 | 1.0 | 0.7 | 96.9 | 2.4 | / |
| Example 18 | 3.4 | 8.1 | 30.4 | 24.9 | 0.36 | 0.9 | 0.3 | 97.0 | 2.7 | / |
| Example 19 | 3.1 | 8.0 | 30.0 | 23.1 | 0.35 | 1.2 | 0.7 | 96.8 | 2.5 | / |
| Example 20 | 3.5 | 8.3 | 30.0 | 22.0 | 0.37 | 1.2 | 0.1 | 97.5 | 2.4 | |

### Example 21

(1) Preparation of a Catalyst Component

To a reactor, in which air had been sufficiently replaced with high pure N₂, were added successively 4.0 g of magnesium dichloride, 50 ml of toluene, 4.0 ml of epoxy chloropropane, 4.0 ml of tributyl phosphate, and 3.4 ml of ethanol. The mixture was heated to 65° C. with stirring. After the solid had been completely dissolved to form a homogeneous solution, 5.5 ml of 2-ethyl hexanol were added dropwise thereto, and the mixture was maintained at 65° C. for further one hour. The reaction mixture was cooled to -5° C., and 60 ml of TiC1₄ were added dropwise and slowly thereto, followed by the addition of 3 ml of tetraethoxy silicane. The reaction was allowed to continue for 0.5 hours. Then the temperature was raised slowly to 85° C., and the reaction was allowed to continue at that temperature for 2 hours. Then the stirring was stopped and the reaction mixture was allowed to stand still. The suspension was observed to separate very quickly into layers. After removing the supernatant, the residue was washed with toluene twice and with hexane four times, and then dried by a flow of high pure N₂. A solid catalyst component having good flowability and narrow particle size distribution was obtained.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and a suspension of the solid catalyst component prepared above in hexane (containing 0.3 mg of Ti). The reactor was heated to 70° C., and hydrogen gas was added thereto until the pressure reached 0.28 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 4.

### Example 22

(1) A catalyst component was prepared according to the same procedure as described in Example 21, except for that the amount of 2-ethyl hexanol was changed from 5.5 ml to 7.7 ml.

(2) Polymerization of ethylene was carried out according to the same procedure as described in Example 21. The polymerization results are shown in Table 4.

### Example 23

(1) A catalyst component was prepared according to the same procedure as described in Example 21, except for that the amount of 2-ethyl hexanol was changed to 3.3 ml.

(2) Polymerization of ethylene was carried out according to the same procedure as described in Example 21. The polymerization results are shown in Table 4.

### Example 24

(1) The catalyst component as prepared in Example 21 was used.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and a suspension of the above solid catalyst component in hexane (containing 0.5 mg of Ti). The reactor was heated to 70° C., and hydrogen gas was added thereto until the pressure reached 0.38 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 4.

### Example 25

(1) The catalyst component as prepared in Example 21 was used.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and a suspension of the above solid catalyst component in hexane (containing 0.8 mg of Ti). The reactor was heated to 70° C., and hydrogen gas was added thereto until the pressure reached 0.48 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 4.

### Example 26

(1) The Catalyst Component as Prepared in Example 21 was used.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and a suspension of the above solid catalyst component in hexane (containing 1.3 mg of Ti). The reactor was heated to 70° C., and hydrogen gas was added thereto until the pressure reached 0.58 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 4.

### Example 27

(1) The Catalyst Component as Prepared in Example 21 was used.

(2) Polymerization of Ethylene

To a 2 L stain-less steel autoclave in which air had been sufficiently replaced with high pure N₂, were added 1 L of hexane, 1.0 ml of 1M solution of triethyl aluminum in hexane, and a suspension of the above solid catalyst component in hexane (containing 1.8 mg of Ti). The reactor was heated to 70° C., and hydrogen gas was added thereto until the pressure reached 0.68 MPa, then ethylene was added thereto until the total pressure inside the reactor reached 0.73 MPa (gauge). The polymerization reaction was allowed to continue at 80° C. for 2 hours, with ethylene being supplied to maintain the total pressure of 0.73 MPa (gauge). The polymerization results are shown in Table 4.

TABLE 4

| | Ti | Activity | | | Particle size distribution of polymer (mesh) | | | | | | | |
|---|---|---|---|---|---|---|---|---|---|---|---|---|
| No. | % | KgPE/gCat. | MI | BD | <20 | 20-40 | 40-60 | 60-80 | 80-100 | 100-140 | 140-200 | >200 |
| Example | 6.2 | 53.1 | 0.71 | 0.34 | 1.3 | 3.1 | 20.3 | 42.8 | 19.7 | 8.0 | 3.0 | 1.6 |
| 21 | | | | | | | | | | | | |
| Example | 5.6 | 42.2 | 0.63 | 0.33 | 2.4 | 5.9 | 25.2 | 36.7 | 15.8 | 7.7 | 4.2 | 2.1 |
| 22 | | | | | | | | | | | | |
| Example | 5.9 | 51.2 | 0.65 | 0.33 | 1.0 | 1.4 | 10.1 | 45.6 | 32.8 | 6.6 | 1.7 | 0.6 |
| 23 | | | | | | | | | | | | |
| Example | 6.2 | 40.8 | 4.10 | 0.34 | 1.5 | 2.1 | 16.1 | 44.2 | 23.0 | 7.5 | 4.1 | 1.5 |
| 24 | | | | | | | | | | | | |
| Example | 6.2 | 28.4 | 9.44 | 0.32 | 1.1 | 2.7 | 20.1 | 30.8 | 30.9 | 8.2 | 5.1 | 1.1 |
| 25 | | | | | | | | | | | | |
| Example | 6.2 | 1.1 | 110.5 | 0.33 | 1.0 | 1.0 | 11.5 | 22.1 | 39.8 | 13.9 | 8.7 | 2.0 |
| 26 | | | | | | | | | | | | |
| Example | 6.2 | 7.5 | 180.6 | 0.33 | 1.0 | 1.9 | 5.1 | 6.4 | 40.9 | 29.2 | 14.1 | 1.4 |
| 27 | | | | | | | | | | | | |

It can be seen from the data shown in Table 4 that, in ethylene polymerization, the catalyst components according to the invention exhibit higher activity, good hydrogen response, and narrow particle size distribution and high bulk density of polymer.

1. A catalyst component for ethylene polymerization, which comprises a reaction product of a magnesium complex, at least one titanium compound, at least one alcohol compound, at least one silicon compound, and optionally an organic aluminum compound, wherein
the magnesium complex is a product obtained by dissolving a magnesium halide in a solvent system comprising an organic epoxy compound and an organo phosphorus compound;
the alcohol compound is a linear or branched alkyl or cycloalkyl alcohol with 1 to 10 carbon atoms,or an aryl or aralkyl alcohol with 6 to 20 carbon atoms, the alcohol compound being optionally substituted by one or more halogen atoms;
the titanium compound has a general formula Ti(OR)ₐX_{b}, in which R is a C₁-C₁₄ aliphatic or aromatic hydrocarbyl , X is a halogen, a is 0, 1 or 2, b is an integer of from 1 to 4, and a+b=3 or 4;
the silicon compound is an organic silicon compound having a general formula R¹ₓR²_{y}Si(OR³)_{z}, in which R¹ and R² are independently a hydrocarbyl or a halogen, R³ is a hydrocarby1, 0≦x≦2, 0≦y≦2, 0≦z≦4, and x+y+z=4;
the organic aluminum compound has a general formula AlR⁴ₙX¹₃₋ₙ, in which R⁴ is hydrogen or a hydrocarbyl having 1 to 20 carbon atoms, X¹ is a halogen, and n is a value satisfying 1<n≦53.

2.-21. (canceled)
